(19) United States
(12) Patent Application Publication
(10) Pub. No.: US 2012/0204906 A1
(43) Pub. Date: Aug. 16, 2012

(54) METHOD OF CONTROLLING A DECONTAMINATION PROCESS

(75) Inventors: G. Marco Bommarito, Stillwater, MN (US); Kelvin J. Witcher, Hudson, WI (US)

(73) Assignee: 3M Innovative Properties Company

(21) Appl. No.: 13/372,833

(22) Filed: Feb. 14, 2012

Related U.S. Application Data
(60) Provisional application No. 61/442,931, filed on Feb. 15, 2011.
(60) Provisional application No. 61/596,554, filed on Feb. 8, 2012.

(51) Int. Cl. B08B 7/04; G06F 19/00

(52) U.S. Cl. 134/18; 702/19

(57) ABSTRACT

A method of controlling a multi-step decontamination process is disclosed. The method comprises assigning articles into a plurality of groups, processing the articles through a first and/or second sub-process of the multi-step decontamination process, quantifying a biological analyte associated with residue on or in the processed articles, and setting action limits for the first and second sub-processes. A method and a system for monitoring the control of the decontamination process are also disclosed.

### CROSS REFERENCE TO RELATED APPLICATIONS

This application claims the benefit of U.S. Provisional Patent Application No. 61/442,931, filed Feb. 15, 2011 and U.S. Provisional Application No. 61/596,554, filed Feb. 8, 2012, both of which are incorporated herein by reference.

### BACKGROUND

The general ability to detect biological soil on any of a variety of surfaces is desired. An assessment of cleanliness is important for the surfaces of medical devices exposed to biological fluids during use. Examples of medical devices include the surfaces of endoscopes, hip impactors, screwdrivers, reamers, ridged reamers, scissors, clamps, and other devices.

While kits are commercially available to test the cleanliness of certain surfaces, available kits typically require samples to be sent to an outside laboratory for analysis. The time involved in sending samples to an outside laboratory for analysis must be factored into the time required for the requester to receive a response. Additionally, culture methods are typically employed in the analysis for pathogens, thus requiring microbiology laboratory equipment and the expertise of trained microbiologists.

In health care fields, medical devices such as endoscopes find utility in medical procedures that expose the devices to biological soil. Endoscopes, for example, are used in medical procedures within a patient's body in which the endoscope is inserted into the body either through a natural orifice or through a surgical opening. Endoscopes include a number of channels. Operating instruments may be passed through the channels of an endoscope, and the channels may be used to deliver fluids or gas, or to provide suction.

As may be apparent, medical instruments are exposed to any of a variety of body soil during their use in surgical procedures. Such soils include blood, fecal matter, cellular matter from various tissues, and the like, and any of these soils may provide sources of viruses or bacteria. Because of their use on and/or in the body, each instrument must be thoroughly cleaned and disinfected following each use to ensure that all of the soil-containing surfaces are disinfected prior to using the medical device in subsequent medical or surgical procedures. In the absence of an effective manual cleaning process, bacterial contamination may not be reduced to sufficiently low levels to render the instrument safe for reuse.

The ability to control the efficacy of a cleaning or disinfecting process for any of a variety of surfaces is desirable.

### SUMMARY

In general, the invention is directed to a method of evaluating the effectiveness of a cleaning and/or disinfecting process.

In one aspect, the present disclosure provides a method of monitoring a multi-step decontamination process. The method can comprise selecting a multi-step decontamination process, the process comprising a first sub process and a second sub process. The method further can comprise assigning articles into a first group and a second group, each group comprising a plurality of the articles. The method further can comprise using the first group to process the first-group articles using a first sub process, to collect first residue from a first predetermined sample region of two or more first-group articles, to quantify a biological analyte to generate a test value for each residue collected from the two or more first-group articles, and to use the first test value and a control value to generate a first normalized value for each of the two or more first-group articles. The method further can comprise using the second group to process the second-group articles using a second sub process, to collect a second residue from a second predetermined sample region of two or more second-group articles, to quantify a biological analyte to generate a second test value for each residue collected from the two or more second-group articles, and to use the test value and a control value to generate a second normalized value for each of the two or more second-group articles. The method further can comprise using a plurality of first normalized values to select a first action limit for articles that are processed using the first sub process, and using a plurality of second normalized values to select a second action limit for articles that are processed using the second sub process.

In any of the above embodiments the second-group articles can be processed in the first sub process before they are processed in the second sub process. In any of the above embodiments, partitioning articles into the first and second groups further can comprise selecting a first portion and a second portion of at least one of the first or second groups, wherein the articles in the first and second portions are selected on the basis of having different types or quantities of visible residue thereon. In any of the above embodiments, each article of the plurality of articles can comprise a medical article. In some embodiments, the medical article can be selected from the group consisting of a grasper, a clamp, an occluder, a retractor, a distractor, a positioner, a stereotactic device, a mechanical cutter, a dilator, a speculum, a sealing device, a needle, a tip, a tube, a tool, a powered device, and a lumened device. In any of the above embodiments, the plurality of articles in the first and/or second group can comprise similar articles. In any of the above embodiments, the plurality of articles in the first and/or second groups can comprise two or more dissimilar articles. In any of the above embodiments, the plurality of articles in the first group and/or the plurality of articles in the second group can comprise similar articles. In any of the above embodiments, the plurality of articles in the first group and/or the plurality of articles in the second group can comprise two or more dissimilar articles. In any of the above embodiments, quantifying the analyte further can comprise quantifying ATP, a bacterium or bacterial component, a virus or viral component, a blood component, or a protein. In any of the above embodiments, wherein selecting a first action limit further can comprise calculating an average of a plurality of the first normalized values and selecting a second action limit further can comprise calculating an average of a plurality of the second normalized values.

In any of the above embodiments, the method further can comprise using the first group to collect a third residue from a third predetermined sample region of the two or more first-group articles, quantify a biological analyte to generate a third test value for each of the third residues collected, use the third test value and a control value to generate a third normalized value for each of the two or more first-group articles, and use a plurality of the third normalized values to select a third action limit for articles that are processed using the first sub process; or, using the second group to collect a fourth residue from a fourth predetermined sample region of the two or more second-group articles, quantify a biological analyte to generate a fourth test value for each of the residues collected, use the fourth test value and the a control value to generate a fourth normalized value for each of the two or more second-group articles, and use a plurality of fourth normalized values to select a fourth action limit for articles that are processed using the second sub process.

In any of the above embodiments, the method further can comprise using the first group to collect a third residue from a third predetermined sample region of the two or more first-group articles, quantify a biological analyte to generate a third test value for each of the third residues collected, use the third test value and a control value to generate a third normalized value for each of the two or more first-group articles, and use a plurality of the third normalized values to select a third action limit for articles that are processed using the first sub process; and using the second group to collect a fourth residue from a fourth predetermined sample region of the two or more second-group articles, quantify a biological analyte to generate a fourth test value for each of the residues collected, use the fourth test value and the a control value to generate a fourth normalized value for each of the two or more second-group articles, and use a plurality of fourth normalized values to select a fourth action limit for articles that are processed using the second sub process.

In any of the above embodiments, at least one of the first, second, third and fourth predetermined sample regions can consist of an exterior surface or, in the alternative, can comprise an exterior surface. In any of the above embodiments, at least one of the first, second, third and fourth predetermined sample regions can consist of an interior surface or, in the alternative, can comprise an interior surface. In any of the above embodiments, the interior surface can consist of the interior of the lumened device or, in the alternative, can comprise the interior of the lumened device.

In another aspect, the present disclosure provides a method of monitoring the control of a multi-step decontamination process. The method can comprise selecting first and second action limits for according to any one of the above embodiments, processing an article using the first sub process or the second sub process, collecting residue from a predetermined sample region of the article, collecting and quantifying a biological analyte from residue collected from a predetermined sample region of the article to generate a test value, using the test value and a control value to generate a normalized value, and performing a predetermined action if the normalized value exceeds the first or second action limit. In any of the above embodiments, the predetermined action can be selected from the group consisting of reprocessing an article, reprocessing a plurality of articles, training operators that operate one or more of the sub-processes of the multi-step process, auditing the process records, adjusting the equipment, auditing the process parameters for one or more sub-processes, adjusting the parameters for one or more sub-processes, testing the activity of a disinfectant or enzyme, replacing a chemical; replacing process equipment, performing equipment maintenance, increasing the frequency of process monitoring, generating an alert, and generating a report.

In another aspect, the present disclosure provides a computer readable medium comprising computer readable instructions. When the computer readable instructions are executed in a processor, the processor can receive a first set of numerical values associated with a first quantified analyte from a first group of articles subjected to a first sub process of a multi-step process, receive a second set of numerical values associated with a second quantified analyte from a second group of articles subjected to a second sub process of the multi-step process, receive a third numerical value associated with a control, use the third numerical value to calculate a first normalized value associated with the first quantified analyte, use the third numerical value to calculate a second normalized value associated with the second quantified analyte, calculate a first average normalized value for the first group, calculate a second average normalized value for the second group, calculate a first action limit using the first average normalized value, and calculate a second action limit using the second average normalized value. In any of the embodiments of the computer readable medium, receiving a third numerical value further can comprise receiving two or more numerical values associated with a control and calculating the average of the two or more numerical values to generate the third numerical value.

In any of the above embodiments of the computer readable medium, the computer readable medium when executed in a processor further can receive a third set of numerical values associated with a third quantified analyte from the first group of articles subjected to the first sub process of the multi-step process, use the third numerical value to calculate a third normalized value associated with the third quantified analyte, calculate a third average normalized value for the first group, and calculate a third action limit using the first average normalized value. In any of the above embodiments of the computer readable medium, the computer readable medium when executed in a processor further can receive a fourth set of numerical values associated with a fourth quantified analyte from the second group of articles subjected to the second sub process of the multi-step process, use the third numerical value to calculate a fourth normalized value associated with the fourth quantified analyte, calculate a fourth average normalized value for the second group, and calculate a second action limit using the second average normalized value.

In another aspect, the present disclosure provides a computer readable medium comprising computer readable instructions. When the computer readable instructions are executed in a processor, the processor can receive first and second action limits selected according to any one of the above embodiments, receive a test value associated with an article that has been processed using the first or second sub processes, receive a control value, use the test value and the control value to calculate a normalized test value, and compares the normalized test value to the first or second action limit. In some embodiments, when the computer readable instructions are executed in a processor, the processor further can receive a third action limit or fourth action limit selected according to any one of the above embodiments, use the test value and the control value to calculate a normalized test value, and compares the normalized test value to the third or fourth action limit. In some embodiments, when the computer readable instructions are executed in a processor, the processor further can execute a predetermined action when the normalized test value exceeds the first or second action limit. In any of the embodiments, the predetermined action can be selected from the group consisting of generating an alert signal, generating a report, initiating a tracking function, performing a site comparison, scheduling a maintenance event, and disabling one or more sub processes of the multi-step processes.

In another aspect, the present disclosure provides a system. The system can comprise an instrument for quantifying a biological analyte from a residue, a processor, and the computer readable medium of any one of the above embodiments.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

“Biological soil”, as used herein, refers to any biological material found on or in a biological organism including, for example, cells, tissue, bone, serum, interstitial fluid, urine, partially-digested food, blood, mucus, secretions, biomolecules, protein, lipids, cell membrane components, endotoxin, polysaccharides, nucleic acid, bacteria, fungi, viruses, and prions.

The terms “comprises” and variations thereof do not have a limiting meaning where these terms appear in the description and claims.

As used herein, “a,” “an,” “the,” “at least one,” and “one or more” are used interchangeably. Thus, for example, a medical article can be interpreted to mean “one or more” medical articles.

The term “and/or” means one or all of the listed elements or a combination of any two or more of the listed elements.

Also herein, the recitations of numerical ranges by endpoints include all numbers subsumed within that range (e.g., 1 to 5 includes 1, 1.5, 2, 2.75, 3, 3.80, 4, 5, etc.).

The above summary of the present invention is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

Additional details of these and other embodiments are set forth in the accompanying drawings and the description below. Other features, objects and advantages will become apparent from the description and drawings, and from the claims.

### BRIEF DESCRIPTION OF DRAWINGS

FIG. 1 is a block diagram of one embodiment of a method of controlling a multi-step decontamination process according to the present disclosure.

FIG. 2 is a block diagram of one embodiment of a method of monitoring the control of a multi-step decontamination process according to the present disclosure.

FIG. 3 is a block diagram of one embodiment of a system for monitoring the control of a multi-step decontamination process according to the present disclosure.

### DETAILED DESCRIPTION

A variety of reusable articles are used in processes (e.g., medical or surgical procedures) that result in the contamination of the article with biological residue. In order to reduce the possibility of transmission of potentially harmful materials (e.g., bacteria, viruses, blood) via the article from one patient to another, the articles are typically subjected to multi-step cleaning and/or disinfecting processes to remove biological residue from the article. The multi-step processes can include, without limitation, sub processes such as soaking, wiping, brushing, scrubbing, washing, contact with a disinfecting agent, contact with a sterilizing agent, or a combination of any two or more of the foregoing. The intent of each sub process is to remove, or prepare for removal, biological residue present on a surface of the article. An advantage of multi-step processes is that the successful execution of an initial or early sub process (e.g., physically wiping the instrument or soaking the instrument in an enzyme detergent solution) can potentiate the efficacy of a subsequent sub process (e.g., a high-pressure liquid wash/rinse or contact with a high-level disinfectant). Conversely, inadequate execution of an initial or early sub process may render a subsequent sub process significantly less effective. Thus, there is an advantage to monitoring two or more sub processes of a multi-step disinfecting process so that standards can be set to keep the multi-step process in control and properly functioning.

The present disclosure generally relates to controlling a multistep process for disinfecting a reusable article (e.g. a medical article). In particular, the present disclosure provides a method of monitoring the efficacy of any sub process of the multistep process and/or the individual or cumulative efficacy of two or more sub processes in the multistep process. The present disclosure further provides a method of setting action limits related to the effectiveness of two or more steps in a multi-step process for cleaning and/or disinfecting a reusable article. The present disclosure further provides a system and a method of controlling a multi-step process for cleaning and/or disinfecting a reusable article.

The present disclosure includes a method of controlling a multi-step process to decontaminate a medical article. Medical articles include, for example, a grasper (e.g., forceps), a clamp, an occluder, a retractors, a distractor, a positioner, a stereotactic device, a mechanical cutter (e.g., a scalpel, a lancet, a rasp, a trocar, a drill bit, a rongeur, a reamer, a ridged reamer, a bone curette, a scissors, a broach), a dilator, a speculum, a sealing device (e.g., a surgical stapler), a needle (e.g., for irrigation or injection), a tip (e.g., for irrigation or suction), a tube (e.g., for irrigation or suction), a tool (e.g., a hip impactor, a screwdriver, a spreader, a hammer, a spreader brace, a probe, a carrier, an applier, a cutting laser guide, a ruler, a calipers, a drill key), a powered device (e.g., a dermatome, an ultrasonic tissue disruptor, a cryotome, a drill), and a lumened device (including multi-lumen devices, the lumened devices including, for example, an endoscope, an arthroscope, a laparoscope, a thoracoscope, a cystoscope, a rhinoscope, a bronchoscope, a colonscope, a choledochoscope, an echoendoscope, an enteroscope, an esophagoscope, a gastroscope, a laryngoscope, a rhinolaryngoscope, a sigmoidoscope, and a duodenoscope).

Initially, the operator must select the multi-step process to be monitored. A non-limiting example of a multi-step process to disinfect a medical article includes an initial soaking sub process to hydrate and, potentially, to remove biological soil that is loosely adhered to the medical article. In some embodiments, the soak solution may comprise one or more enzymes and/or surfactants to facilitate the disintegration of the biological soil. The exemplary multi-step process further includes wiping the instrument with a cloth or paper towel, for example, to remove the loosened soil residue. The process further includes the sub-processes of scrubbing and/or washing the medical article. The article is scrubbed with a brush or a sponge, for example. The exemplary multi-step process includes a rinse, to dislodge and/or dilute residue remaining from the previous steps. The terminal sub-process in the multi-step process is contacting the article with a high-level disinfectant under conditions (e.g., time and temperature) that facilitate the inactivation of biological agents such as bacteria and viruses, for example.

Without being bound by theory, it will be appreciated by a person having ordinary skill in the art that subjecting an article to each of the sub-processes (e.g., soaking, wiping, scrubbing, washing, rinsing, and disinfecting) of the multi should result in a lower amount of biological soil adhered to the article after each successive sub-process. It is advantageous to monitor the efficacy of non-terminal sub-processes to avoid significant cross-contamination from poorly-cleaned instruments to those that have been adequately-cleaned. This is because, for example, some processes may involve combining in one sub-process two or more articles that were processed separately in the preceding sub-process.

The multi-step decontamination process is used to disinfect medical articles. In certain preferred embodiments, the multi-step decontamination process is used to disinfect medical articles that are used in a first medical or surgical procedure, are subsequently processed through the multi-step process, and are then re-used in another medical or surgical procedure. Optionally, the articles may also be subjected to a sterilization process.

Method of Controlling a Multi-Step Decontamination Process

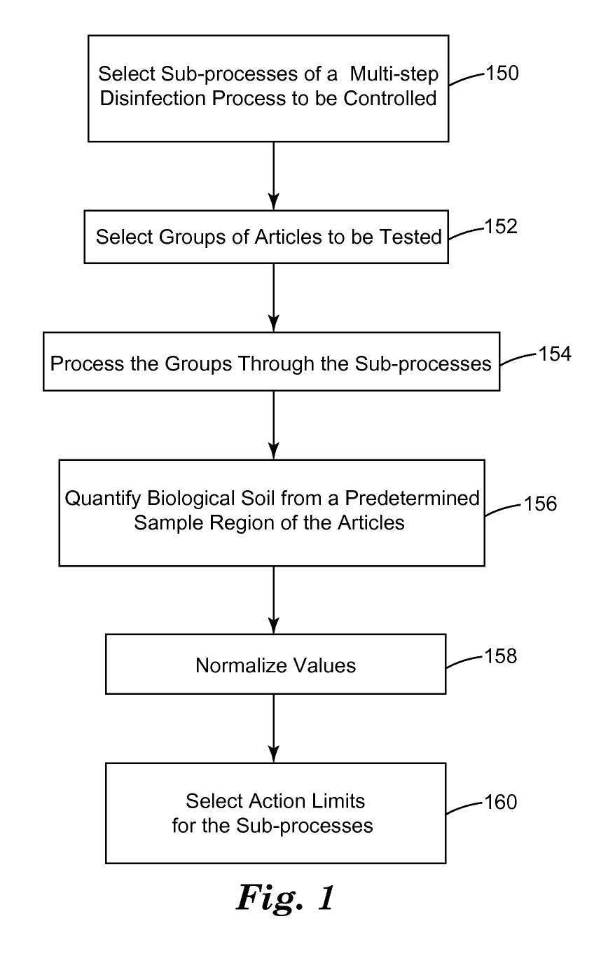

FIG. 1 shows a block diagram of one embodiment of a method of controlling a multi-step decontamination process according to the present disclosure. The method comprises the step 150 of selecting two or more sub-processes (i.e., selecting at least a first sub-process and a second sub process) of the multi-step process to be controlled. “First” and “second” sub-processes, as used herein, merely distinguish between two distinct sub-processes and do not necessarily relate to the order in which they are normally performed in the execution of the multi-step decontamination process. The selected sub-processes can be any sub-process intended to remove and/or inactivate (e.g., kill or lyse cells) biological soil on or in an article. In some embodiments, the one of the selected sub-processes is the terminal sub-process (i.e., the sub-process that is performed as the last step in the multi-step process).

The method further comprises the step 152 of selecting a first group comprising a plurality of articles to be tested. The first group of articles is tested after being processed in the selected first sub-process. The first group can be selected on the basis of a variety of factors including, for example, i) the group comprises a representative mixture of the broad variety (e.g., sizes, shapes, materials) of articles that are processed in the multi-step decontamination process, ii) the group comprises the articles that are most-commonly processed in the multi-step decontamination process, iii) the group comprises the articles that are thought to be the most difficult to clean and/or disinfect in the first sub-process, a second sub-process, and/or the entire multi-step decontamination process or iv) the group comprises articles with various amounts of soil (e.g., some are heavily/visibly soiled, some are somewhat/visibly soiled, some are lightly soiled, and some are not visibly soiled).

Selecting a first group of articles further comprises selecting a second group comprising a plurality of articles to be tested. The second group of articles is tested after being processed in the selected second sub-process. In any embodiment, articles in the second group can be selected on the same basis as the articles in the first group. In any embodiment, articles in the second group can be selected on a different basis than the articles in the first group. In some embodiments, wherein the first group of articles comprises a portion of the second group of articles, it is understood that the portion of articles are tested after both the first and second sub-processes.

In some embodiments, the plurality of articles in the first and/or second group comprises similar articles. That is, the group comprises a homogeneous group of one particular type of medical articles (e.g., scissors, forceps or spreaders). The homogeneous group may further comprise articles of a homogeneous size, shape, and/or design. Alternatively, the homogeneous group may comprise similar articles (i.e., bone curettes) of different sizes. This embodiment can permit the operator to monitor the efficacy of the process for cleaning a particular type of medical article.

In some embodiments, the plurality of articles in the first and/or second group comprises dissimilar articles. That is, the group comprises a nonhomogeneous group of two or more particular types of medical articles (e.g., various combinations of two or more types of instruments that may include, for example, scissors, forceps, drills and/or spreaders). The nonhomogeneous group may further comprise articles of a generally similar size and/or shape. Alternatively, the nonhomogeneous group may comprise dissimilar articles of different sizes. This embodiment can permit the operator to monitor the efficacy of the process for cleaning a particular combination of medical articles (e.g., a variety of articles that are used in a particular type of surgery such as, for example, a joint replacement surgery).

In some embodiments, at least some of the articles of the first group are also articles of the second group. That is, the first and second groups of articles are not necessarily mutually exclusive. In some embodiments, all of the articles of the first group are also articles of the second group. Thus, in these embodiments of the method, at least some of the articles are tested after being processed in the selected first sub-process and are tested after being processed in the selected second sub process.

The number of articles in each of the first and second groups can be the same or can be different. Because the test results are used to calculate action limits to control the multi-step process, it is advantageous to select enough articles in each group to have a reasonable representation of the variability that may be seen in a larger population of articles that are subjected to the multi-step process. In some embodiments, the first and second groups each comprise at least three articles. In some embodiments, the first and second groups each comprise at least five articles. In some embodiments, the first and second groups each comprise at least ten articles. In some embodiments, the first and second groups each comprise at least fifteen articles. In some embodiments, the first and second groups each comprise at least twenty articles. In some embodiments, the first and second groups each comprise at least thirty articles. In some embodiments, the first and second groups comprise more than thirty articles.

Referring back to FIG. 1, the method further comprises the step 154 of processing the first and second groups of articles using the selected first and second sub-processes, respectively. In preferred embodiments, processing the first and second groups of articles using the selected first and second sub-processes further comprises prior processing the first and second groups of articles using the other sub-processes, if any, which normally precede the selected first and second sub-processes.

After the first group of articles is processed in the first sub-process, each article in the group is tested for the amount of one or more biological soil analytes present in a predetermined sample region of the article, as shown in step 156. The article is tested for the presence of biological soil by removing a sample of surface residue from the article and analyzing the sample for a biological analyte associated with biological soil. Non-limiting examples of suitable biological analytes include nucleotides (e.g., ATP, ADP, or NADH), nucleic acids (e.g., a polynucleotide associated with a particular type of cell or microorganism), hemoglobin or heme iron (e.g., indicating the presence of blood cells or components thereof), proteins (e.g., total protein residue, enzymes, or a proteinaceous antigen), lipids, endotoxin, cell membrane components, and carbohydrates (e.g., simple sugars, polysaccharides). Analytical procedures to detect the biological analytes are known in the art. Preferred biological analytes to be detected include hemoglobin and total protein, for example. A particularly preferred biological analyte to be detected is ATP, which can be detected and quantitated via a bioluminescent reaction using, for example, a 3M™ CLEAN TRACE swab with a 3M CLEAN TRACE NG reader (both the CLEAN TRACE swab and NG reader are available from 3M Company, St. Paul, Minn.). In some embodiments, the analytical procedure may include steps to concentrate and/or purify the particular biological analyte to be detected.

The size and location of the sample region is typically predetermined and may vary according to the article and/or the particular sub-process being tested. For example, articles that are tested after sub-processes that occur early in the multi-step process may be expected to have a relatively higher amount of biological soil thereon and, thus, a relatively smaller portion can be sampled. In contrast, articles that are tested after sub-processes that occur later in the multi-step process may be expected to have a relatively lower amount of biological soil thereon and, thus, a relatively larger portion can be sampled. Furthermore, articles with 3-dimensional structure (e.g., openings, indentations, hinges, hollow tubes, reservoirs, crevices, the interior surface of a lumen, and the like) may be sampled in the 3-dimensional areas in which the biological soil may be sequestered from the action (e.g., soaking, wiping, scrubbing, spraying) of a sub-process that is intended to remove the soil.

In some embodiments, the sampling area (i.e., the surface area of the article from which any biological soil will be obtained) may be about 5 mm² or greater. In some embodiments, the sampling area (i.e., the surface area of the article from which any biological soil will be obtained) may be about 50 mm² or greater. In some embodiments, the sampling area (i.e., the surface area of the article from which any biological soil will be obtained) may be about 100 mm² or greater. In some embodiments, the sampling area (i.e., the surface area of the article from which any biological soil will be obtained) may be about 500 mm² or greater. In some embodiments, the sampling area (i.e., the surface area of the article from which any biological soil will be obtained) may be about 10,000 mm² or greater. In some embodiments, the sampling area (i.e., the surface area of the article from which any biological soil will be obtained) includes about the entire accessible surface area of the article.

The sampling area of the article can be sampled by a variety of sampling methods known in the art. In some embodiments, the sampling area is rinsed with a liquid (e.g., sterile water, saline, or buffer solution), the liquid is collected in a suitable container, and the liquid is used in an analytical procedure to detect a biomolecule that is indicative of biological soil. In some embodiments, a portion of the article or the entire article is immersed in a liquid (e.g., sterile water, saline, or buffer solution), the liquid is collected in a suitable container, and the liquid is used in an analytical procedure to detect a biomolecule that is indicative of biological soil. In some embodiments, the sampling area is contacted with a sample acquisition device (e.g., a swab, a sponge, a wipe), which is subsequently used in an analytical procedure to detect a biomolecule that is indicative of biological soil. In some embodiments, the sample acquisition device may be pre-moistened (e.g., with sterile water or a buffer) before it is contacted with the sampling area of the article. In some embodiments, the sample acquisition device is immersed in a liquid sample to obtain a portion of the liquid to be tested. Sample acquisition devices (e.g. swabs) can be particularly useful in obtaining sample material from crevices, hinges, and lumina, for example.

Testing the sample from an article further comprises quantifying a biomolecule (e.g., ATP, protein, a biomolecule found in blood) in the sample to generate a test value for each sample. In some embodiments, the test value is quantified in terms of absolute units (e.g., molecules, mass, or molarity) of the detected biomolecule in the sample. In some embodiments, the test value is quantified in terms of relative units (e.g., relative light units or RLU, as in certain bioluminescent assays for ATP; absorbance units or AU as in certain colorimetric assays for protein, such as a biuret assay or a BCA assay) of biological analyte or biological analyte reactivity (e.g., enzyme activity).

In some embodiments, the test value can be transformed by converting the test value to a Log₁₀ test value, for example. In these embodiments, the control value can be transformed similarly and the transformed test value can be used with the transformed control value to calculate a normalized test value.

In any of the embodiments, after the biological analyte from each article is quantified, the test values are normalized, as indicated in step 158 of FIG. 1. Normalizing the test values minimizes the effect of non-specific “noise” in the assay due to, for example, sample-to-sample reagent variability and/or instrument variability. An example of a detection system for which the test values are normalized according to the present disclosure is an ATP bioluminescent detection system.

Normalizing a test value according to the present disclosure can comprise subtracting a control value (i.e., background) from the value obtained using a test sample. The control value can be produced using a control reaction that employs similar reagents and instruments as the test samples except that the control reaction does not include any residue collected from an article. In an alternative embodiment, a normalizing a test value can comprise calculating a ratio of the test value to the control value (e.g., by dividing the test value by the control value. In yet another alternative embodiment, the control value can be associated with a calibrated color source or light source, which can be used to adjust the detector to a specified baseline value. In some embodiments (e.g., a colorimetric protein assay), the control reaction can be used as a reference sample to adjust the baseline of the instrument.

After the test values are converted to normalized values, a plurality of normalized values is used to select an action limit for the first and/or second sub-process of the multi-step decontamination process, as indicated in step 160 of FIG. 1. “Action limit”, as used herein refers to a threshold amount of biological analyte, detected in the residue collected from an article according to a pre-defined sample collection method and a pre-defined analyte detection method, which indicates a particular sub-process or a series of sub-processes failed to remove or inactivate an acceptable amount of biological soil from the article. In some embodiments, the threshold amount is actionable (i.e., the action is indicated if the detected amount of biological soil is greater than or equal to the threshold amount). In some embodiments, the threshold amount value is not actionable (i.e., the action is indicated only if the detected amount of biological soil is greater than the threshold amount).

It is contemplated within the present disclosure that one or more articles in the first and/or second group of articles may be used to collect residue from a plurality of predetermined sample regions on or in the article. By way of example, the first group of articles may comprise lumened devices (e.g., colonoscopes) and the second group of articles may comprise scissors. In one implementation of the method, a first residue may be collected from a first predetermined sample region (a portion of the exterior surface of the insertion tube) of articles in the first group and a second residue may be collected from a second predetermined sample region (e.g. a portion of the cutting surface) of articles in the second group. After quantifying a biological analyte in the pluralities of first and second residues, the test results can be used to select first and second action limits for at least two sub-processes of a multi-step process, as described herein. Optionally, a third residue further may be collected from a third predetermined sample region (e.g., a portion of the interior surface of the biopsy channel) of articles in the first group and/or a fourth residue may be collected from a fourth sample region (e.g., a portion of the handle) of articles in the second group. After quantifying a biological analyte in the pluralities of third and fourth residues, the test results can be used to select third and/or fourth action limits for at least two sub-processes of a multi-step process, similar to the method of selecting first and second action limits as described herein.

A plurality of test values associated with the plurality of articles in the first group is used to select at least one action limit for the first sub-process. Similarly, a plurality of test values associated with the plurality of articles in the second group is used to select at least one action limit for the second sub process. In order to control the multi-step decontamination process, the action limit for any of the individual sub-processes can be selected based upon the natural variability of the sub-process result. Advantageously, this approach takes into account variability that may be due to the number and/or variety of articles (e.g., size, shape, number of articles per batch, relative amount of biological soil on the article after the medical procedure) treated in the sub-processes as well as variability due to the parameters of the sub-process itself (e.g., temperature, humidity, operator, and/or concentration of disinfecting agent or surfactant). In contrast to visual inspection, which can yield data based upon subjective criteria, the inventive method advantageously provides objective data that can be used to monitor and evaluate the process and sub-processes. Furthermore, the use of objective method described herein facilitates meaningful comparisons between two or more different operators, machines, and/or test sites.

In some embodiments, selecting the action limits for any given sub-process can comprise using statistical process control. For example, in one embodiment, the average ( x̅) test value and the standard deviation (σ) of the average test value of the plurality of articles from the first group are calculated and the action limit for the first and or second sub-process is selected as the value of the mean plus the value of a multiple of the standard deviation. For example, the multiple may be one times the standard deviation, two times the standard deviation, three times the standard deviation, or the like. An advantage of ATP detection methods is that the results are available and actionable almost immediately.

In any of the above embodiments, the method further can comprise selecting a plurality of portions (e.g., at least a first and second portion) of the first group, the second group, or the first and second groups. In some embodiments, the portions can be processed simultaneously. In some embodiments, the portions can be processed separately. The portions can be selected on the basis of particular features associated with articles in the selected portion. Non-limiting examples of particular features include article size, article shape, article mass, three-dimensional features (e.g., reservoirs and/or lumina), and the type and/or quantity of residue (e.g. biological soil) on or in the article. In some embodiments, the quantity of biological soil may be distinguished visibly. An advantage of including a plurality of portions or articles within the first and/or second group is that it permits the operator to observe whether processing the portions simultaneously can have a substantial effect compared to processing the portions separately.

Method of Monitoring the Control of a Multi-Step Decontamination Process

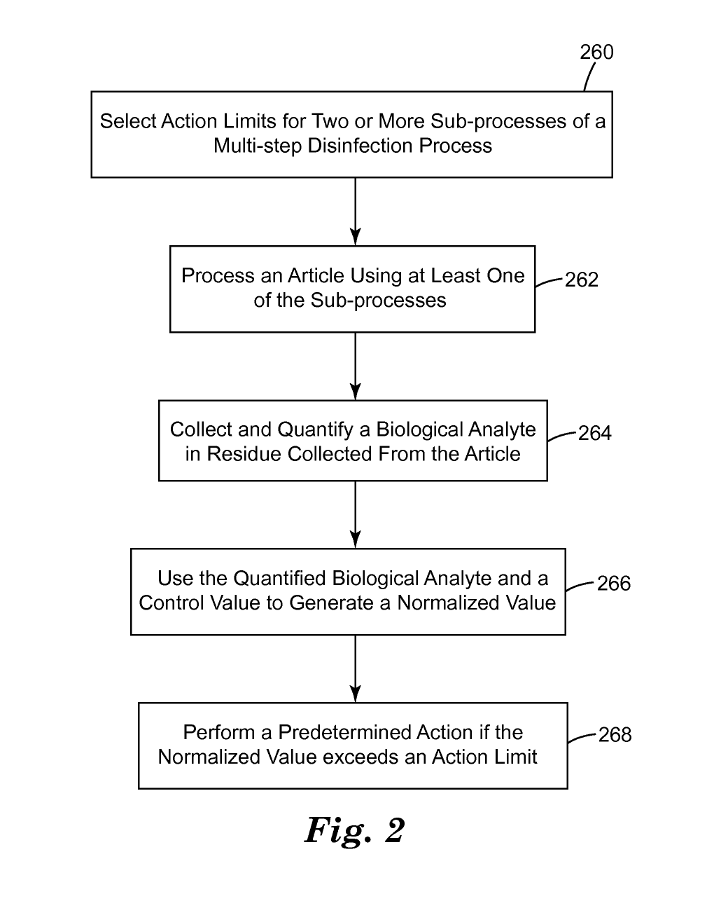

In another aspect, the present disclosure provides a method of monitoring the control of a multi-step decontamination process. FIG. 2 shows a block diagram of one embodiment of the method according to the present disclosure. The method comprises the step 260 of selecting action limits for at least two sub-processes (e.g., a first sub-process and a second sub-process) of a multi-step disinfecting process, as described herein. The action limits relate to unacceptable amounts of a biological soil analyte that can be detected on or in an article treated with the decontamination process.

The method further comprises the step 262 of processing an article using the first and/or second sub-process. If the second sub-process normally occurs after the first sub-process and/or any other prior or intervening sub-processes; in some embodiments, processing the article using the second sub-process further comprises prior processing the article with the second sub-process and any other prior sub-processes of the multi-step decontamination process.

The method further comprises the step 264 of collecting and quantifying a biological analyte from residue collected from a predetermined sample region of the article to generate a test value. The residue can be collected from the predetermined sample region as described herein. The collected residue further can be analyzed to quantitate a biological analyte and generate a test value as described herein.

The method further comprises the step 266 of using the test value and a control value to generate a normalized value. The normalized value can be generated as described herein.

The method further comprises the step 268 of performing a predetermined action if the normalized value exceeds the first or second action limit. Typically, the predetermined action is a process intended to adjust a parameter of the multi-step process in order to bring it back into control (e.g., subsequent articles that are tested do not exceed the action limits), to temporarily or permanently interrupt the process so that no additional articles are processed until the sub-processes are brought back into control, and/or to notify an operator or a manager that at least one of the sub-processes has exceeded an action limit for that sub-process. Exemplary predetermined actions include, but are not limited to, reprocessing an article; reprocessing a plurality of articles; training operators that operate one or more of the sub-processes of the multi-step process; auditing the process records (e.g., with regard to the operators and/or equipment); adjusting the equipment (e.g., temperature); auditing the process parameters for one or more sub-processes; adjusting the parameters (e.g., temperature, contact time, concentration or type of disinfectant) for one or more sub-processes; testing the activity of a disinfectant or enzyme; replacing a chemical; replacing process equipment; performing equipment maintenance; increasing the frequency of process monitoring; generating an alert (e.g., a visual alert, an audio alert); and generating a report (e.g., a printed and/or electronic report).

Computer Readable Media

It is contemplated within the invention that aspects of the method can be automated to improve the accuracy and/or efficiency of the method. In some embodiments, the computer readable medium can be a non-transitory computer readable medium. Memory is one example, of a computer readable medium that stores processor executable software instructions applied by a processor. By way of example, the memory may comprise non-transitory computer readable media such as, for example, random access memory (RAM), read-only memory (ROM), non-volatile random access memory (NVRAM), electrically erasable programmable read-only memory (EEPROM), flash memory, or the like. Also, computer readable medium may include nontransitory media such as an electromagnetic carrier wave, e.g., for delivering the software over a network such as the internet. Computer readable instructions such as those described herein can be stored in the memory and may form part of a larger software program for inventory control, for example.

In some embodiments, a processor can execute computer readable instructions to receive a plurality of test values and one or more control values. The processor further can execute instructions to use the values to calculate normalized values and, optionally, calculate an action limit. In some embodiments, a processor can execute instructions to receive a plurality of normalized values and use the normalized values to calculate an action limit.

Thus, the present disclosure also provides a computer readable medium comprising computer readable instructions. In one embodiment, when the computer readable instructions are executed by the processor, the processor receives a first set of numerical values associated with a quantified analyte from a first group of articles subjected to a first sub-process of a multi-step process, receives a second set of numerical value associated with a quantified analyte from a second group of articles subjected to a second sub-process of the multi-step process, receives a third numerical value associated with a control, uses the third numerical value to calculate a normalized value associated with the quantified analyte for each one of a plurality of articles in the first and second groups, calculates a first average normalized value for the first group, calculates a second average normalized value for the second group, calculates a first action limit using the first average normalized value, and calculates a second action limit using the second average normalized value. In some embodiments of the computer readable medium, receiving a third numerical value further comprises receiving two or more numerical values associated with a control and calculating the average of the two or more numerical values to generate the third numerical value.

In some embodiments, a computer readable medium comprising computer readable instructions can be used to monitor the control of a multi-step disinfecting process. In one embodiment, when executing the computer readable instructions of the computer readable medium, the processor receives first and second action limits selected according to any one of embodiments described herein, receives a biological analyte test value associated with an article that has been processed using the first or second sub processes, receives a control value, uses the test value and the control value to calculate a normalized test value, and compares the normalized test value to the first or second action limit. In some embodiments, when the computer readable instructions are executed by a processor, the processor further executes a predetermined action when the normalized test value exceeds the first or second action limit. The predetermined action, for example, can be selected from the group consisting of generating an alert signal, generating a report, generating a trend line, initiating a tracking function (e.g., following an instrument through reprocessing or deployment for a medical procedure), performing a site comparison (e.g., comparing monitoring test results from two or more independent clinical sites), scheduling a maintenance event, and disabling one or more sub processes of the multi-step processes.

System for Monitoring or Controlling a Multi-Step Decontamination Process

The present disclosure also provides a system for monitoring or controlling a multi-step decontamination process. The system comprises an instrument capable of quantifying a biological analyte, a processor, and a computer readable medium comprising computer readable instructions to monitor the control of a multi-step disinfecting process, as described herein.

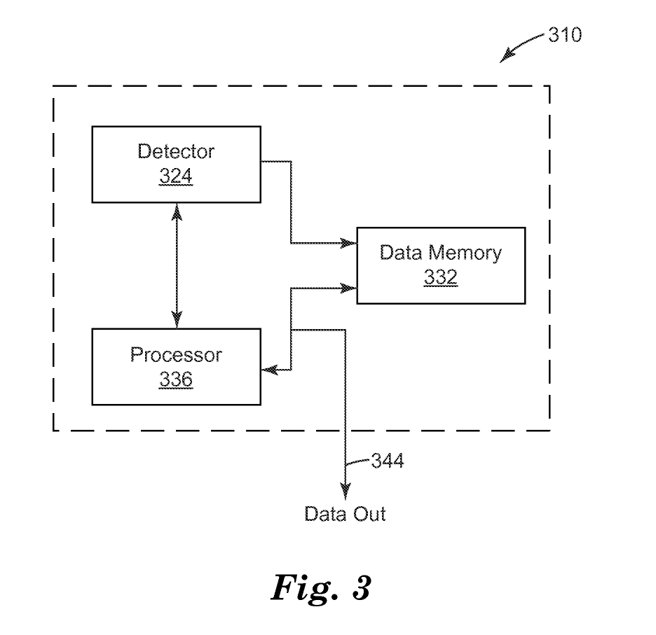

FIG. 3 shows one embodiment of a system 310 according to the present disclosure. In this embodiment, components of the system 310 include a detector 324, data memory 332, and a processor 336. The detector 324, data memory 332, and processor 336 are capable of inter-component communication, as illustrated by the arrows. Optionally, all components of the system 310 are housed in a single instrument, as indicated by the dashed line. Alternatively, components of the system 310 (e.g., the detector and the processor) may be housed in two or more instruments (not shown).

The detector 324 is an instrument capable of quantifying a biological analyte. Suitable detectors to quantify biological analytes are known in the art and include, for example, spectrophotometers, fluorometers, potentiostats, electrometers, and luminometers (e.g., 3M CLEAN TRACE NG reader). The detector 324 may be controlled by processor 336 and may pass instructions or test data to the processor 336 and/or data memory 332. Furthermore, test data may be transmitted out of the system 310 via a data transmission means 344. Nonlimiting examples of data transmission means include copper wires, optical fibers, wireless communication channels (e.g., radio wave, microwave, or infrared signals), and storage media (e.g., compact disk or flash drive memory). In some embodiments, the data may be transmitted to a display (e.g., a computer monitor, a screen display, a touch screen, not shown) or a printing device (not shown).

The processor 336 may comprise a general-purpose microprocessor that executes software stored in memory 332. Alternatively, processor 336 may comprise an application specific integrated circuit (ASIC) or other specifically designed processor. In any case, processor 336 executes various mathematical processes described herein to calculate the action limits for a particular article that has been treated with a particular sub-process.

Memory 332 is one example, of a computer readable medium that stores processor executable software instructions applied by processor 336. By way of example, memory 332 may comprise random access memory (RAM), read-only memory (ROM), non-volatile random access memory (NVRAM), electrically erasable programmable read-only memory (EEPROM), flash memory, or the like.

In some embodiments, calculating action limits as described herein is a software-implemented process. Further, in some embodiments, comparing a test result to an action limit and, optionally, reporting the test result as passing or failing with respect to the action limit is a software-implemented process. In these embodiments, a computer readable medium stores processor executable instructions that embody one or more of the calculations and/or comparisons described above. For example, the computer readable medium may comprise nontransitory media such as random access memory (RAM), read-only memory (ROM), non-volatile random access memory (NVRAM), electrically erasable programmable read-only memory (EEPROM), flash memory, or the like. The computer readable medium may also comprise a non-volatile memory such as a CD-ROM used to deliver the software to customers. Also, the computer readable medium may comprise nontransitory media such as an electromagnetic carrier wave, e.g., for delivering the software over a network such as the internet.

The same calculations or comparisons, however, may also be implemented in hardware. Example hardware implementations include implementations within an application specific integrated circuit (ASIC), a field programmable gate array (FPGA), specifically designed hardware components, or any combination thereof. In addition, one or more of the techniques described herein may be partially executed in hardware, software or firmware.

In any case, various modifications may be made without departing from the spirit and scope of the invention. For example, one or more of the rules described herein may be used with or without other rules and various subsets of the rules may be applied in any order, depending on the desired implementation. These and other embodiments are within the scope of the following claims. The following serves to illustrate one embodiment of a method to control a multi-step decontamination process by establishing a monitoring process, a validation process, and by establishing actions limits for monitoring the process and keeping it in control.

An exemplary technology to monitor a decontamination process is detection of ATP-mediated bioluminescence. The amount of ATP (adenosine triphosphate), a biomolecule commonly found in biological soil, can easily and sensitively be measured in a reaction with luciferase enzyme and luciferin. A number of portable luminometers are commercially available and can be used in conjunction with a swab device to measure ATP in a sample. Advantageously, the results of an ATP bioluminescent assay are available almost immediately; allowing the predetermined action to be executed within minutes after the sample has been obtained.

Benchmark data is collected to determine the efficacy of the multi-step decontamination process. These data are collected by processing a plurality of articles using the multi-step process. In some multi-step processes (or sub-processes), a plurality of articles are subjected to the multi-step process (or sub-process) as a group or “batch”. In some multi-step processes (or sub-processes), articles are subjected to the multi-step process (or sub-process) individually. Hereinafter, processing an individual article or a batch of articles using the entire multi-step process is referred to performing a “decontamination cycle”. An initial step in collecting the benchmark data is selecting the number of decontamination cycles to monitor. Additionally, or alternatively, the operator can select a time period during which the benchmark data will be collected.

When designing the validation procedure to collect the benchmark data, care can be taken to select articles with specific characteristics. For example, a specified number of article (e.g., at least 3) can be selected because they are considered heavily-soiled and relatively difficult to clean (e.g., because of surface topology such as crevices or lumina that may be difficult to reach with a brush and/or disinfectant solution). Additionally, for example, a specified number of articles (e.g., at least 3), can be selected because they are considered heavily-soiled and relatively easy to clean (e.g., smooth, flat, easily-accessible surfaces). Additionally, for example, a specified number of articles (e.g., at least 3) can be selected because they are considered lightly soiled. A person having ordinary skill in the art will recognize other features (e.g., type of article) that may be used as a basis for selecting it for use in the validation procedure.

Benchmark data can be collected for each article before a decontamination cycle (e.g., when the instrument is received for decontamination) and after one or more of each sub-process of the decontamination cycle (e.g., after soaking in a liquid that may contain enzymes and/or detergent, after treatment in a sonication bath, after manual washing, and/or after washing in an automated washer-disinfector). The benchmark data are collected by i) sampling a predetermined portion (e.g., a particular amount of surface area at a particular location on and/or in the article) of the article as described herein and ii) quantifying an amount of biological analyte (e.g., ATP, protein) present in the sample. In some embodiments, the entire surface of the article can be sampled (e.g., by contacting it with a swab). In some embodiments, the repeatability of the test can be determined by sampling the entire surface of the article a plurality of times (e.g., contacting the entire surface with a different swab each time). With each batch of samples tested, at least one control is run in order to generate normalized values, as described herein.

After the benchmark test and control value data are collected, the data are used to calculate action limits for a particular sub-process and/or for the overall multi-step process. Initially, an average and a standard deviation are calculated for the normalized values associated with each sub-process. The average and standard deviation are used to set action limits for the process. For example, a “pass” limit can be set as any normalized value that is less than the sum of the average plus one standard deviation. Thus, any subsequent test value falling within the “pass” range indicates that no action need be taken with respect to the decontamination process. Additionally, a “fail” limit can be set as any normalized value that is greater than the sum of the average plus two standard deviations. Thus, any subsequent test value that is higher than the “fail” limit may indicate the need to perform a predetermined action with respect to the decontamination process, as described herein. Additionally, a “caution range” can be set as any normalized value that falls between the sum of the average plus one standard deviation and the sum of the average plus two standard deviations, inclusive. Thus, any subsequent test value that is within the caution range may indicate the need to perform a predetermined action (e.g., reprocess the article). Following these exemplary guidelines, statistically theory would predict that, as long as the process runs “in control” (i.e. as it did when you benchmarked it), 88% of tested instruments should have normalized values within the pass range and 97.5% of tested instruments should have normalized values below the caution-fail threshold. Only 2.5% of the tested instruments would have a normalized value above the fail limit.

The pass-caution-fail values described above can be generated by a processor using in a hosted software system that is resident in a detection device (e.g. a luminometer for detecting ATP on surfaces). The detection device can be used with the hosted software to implement the process control methods described herein.

### EMBODIMENTS

Embodiment 1 is a method of controlling a multi-step decontamination process, comprising

selecting a multi-step decontamination process, the process comprising a first sub process and a second sub process;

assigning articles into a first group and a second group, each group comprising a plurality of the articles;

using the first group to
process the first-group articles using a first sub process;
collect residue from a predetermined sample region of two or more first-group articles;
quantify a biological analyte to generate a test value for each residue collected from the two or more first-group articles;
use the test value and a control value to generate a first normalized value for each of the two or more first-group articles;

using the second group to
process the second-group articles using a second sub process;
collect residue from a predetermined sample region of two or more second-group articles;
quantify a biological analyte to generate a test value for each residue collected from the two or more second-group articles;
use the test value and a control value to generate a second normalized value for each of the two or more second-group articles;

using a plurality of first normalized values to select a first action limit for articles that are processed using the first sub process; and

using a plurality of second normalized values to select a second action limit for articles that are processed using the second sub process.

Embodiment 2 is the method of embodiment 1, wherein a first article is in both the first group and the second group of articles.

Embodiment 3 is the method of embodiment 1 or embodiment 2, wherein the second-group articles are processed in the first sub process before they are processed in the second sub process.

Embodiment 4 is the method of any one of the preceding embodiments, wherein partitioning articles into the first and second groups further comprises selecting a first portion and a second portion of at least one of the first or second groups, wherein the articles in the first and second portions are selected on the basis of having different types or quantities of visible residue thereon.

Embodiment 5 is the method of any one of the preceding embodiments, wherein each article of the plurality of articles comprises a medical article.

Embodiment 6 is the method of any one of the preceding embodiments, wherein the medical article is selected from the group consisting of a grasper, a clamp, an occluder, a retractors, a distractor, a positioner, a stereotactic device, a mechanical cutter, a dilator, a speculum, a sealing device, a needle, a tip, a tube, a tool, a powered device, and a lumened device.

Embodiment 7 is the method of any one of the preceding embodiments, wherein the plurality of articles in the first group and/or the plurality of articles in the second group comprise similar articles.

Embodiment 8 is the method of any one of the preceding embodiments, wherein the plurality of articles in the first group and/or the plurality of articles in the second group comprise two or more dissimilar articles.

Embodiment 9 is the method of any one of the preceding embodiments, wherein quantifying the analyte further comprises quantifying ATP, a bacterium or bacterial component, a virus or viral component, a blood component, or a protein.

Embodiment 10 is the method of any one of the preceding embodiments, wherein wherein selecting a first action limit further comprises calculating an average of a plurality of the first normalized values and selecting a second action limit further comprises calculating an average of a plurality of the second normalized values.

Embodiment 11 is the method of embodiment 10, wherein the selected action limit is about one standard deviation above the average.

Embodiment 12 is the method of embodiment 10, wherein the selected action limit is about two standard deviations above the average.

Embodiment 13 is the method of any one of the preceding embodiments, further comprising:

using the first group to:
collect a third residue from a third predetermined sample region of the two or more first-group articles;
quantify a biological analyte to generate a third test value for each of the third residues collected;
use the third test value and a control value to generate a third normalized value for each of the two or more first-group articles; and
use a plurality of the third normalized values to select a third action limit for articles that are processed using the first sub process; or

using the second group to:
collect a fourth residue from a fourth predetermined sample region of the two or more second-group articles;
quantify a biological analyte to generate a fourth test value for each of the residues collected;
use the fourth test value and the a control value to generate a fourth normalized value for each of the two or more second-group articles; and
use a plurality of fourth normalized values to select a fourth action limit for articles that are processed using the second sub process.

Embodiment 14 is the method of any one of the preceding embodiments, further comprising:

using the first group to:
collect a third residue from a third predetermined sample region of the two or more first-group articles;
quantify a biological analyte to generate a third test value for each of the third residues collected;
use the third test value and a control value to generate a third normalized value for each of the two or more first-group articles; and
use a plurality of the third normalized values to select a third action limit for articles that are processed using the first sub process; and

using the second group to:
collect a fourth residue from a fourth predetermined sample region of the two or more second-group articles;
quantify a biological analyte to generate a fourth test value for each of the residues collected;
use the fourth test value and the a control value to generate a fourth normalized value for each of the two or more second-group articles; and
use a plurality of fourth normalized values to select a fourth action limit for articles that are processed using the second sub process.

Embodiment 15 is the method of any one of the preceding embodiments, wherein at least one of the first, second, third and fourth predetermined sample regions consists of an exterior surface.

Embodiment 16 is the method of any one of the preceding embodiments, wherein at least one of the first, second, third and fourth predetermined sample regions consists of an interior surface.

Embodiment 17 is the method of embodiment 16, wherein the interior surface consists of the interior of a lumened device.

Embodiment 18 is the method of any one of embodiments 1 through 14, wherein at least one of the first, second, third and fourth predetermined sample regions comprises an exterior surface.

Embodiment 19 is the method of any one of embodiments 1 through 14, wherein at least one of the first, second, third and fourth predetermined sample regions comprises an interior surface.

Embodiment 20 is the method of embodiment 19, wherein the interior surface comprises the interior of a lumened device.

Embodiment 21 is a method of monitoring the control of a multi-step decontamination process, comprising:

selecting first and second action limits for according to any one of embodiments 1 through 20;

processing an article using the first sub process or the second sub process;

collecting and quantifying a biological analyte from residue collected from a predetermined sample region of the article to generate a test value;

using the test value and a control value to generate a normalized value; and

performing a predetermined action if the normalized value exceeds the first or second action limit.

Embodiment 22 is the method of embodiment 21, wherein the predetermined action is selected from the group consisting of reprocessing an article, reprocessing a plurality of articles, training operators that operate one or more of the sub-processes of the multi-step process, auditing the process records, adjusting the equipment, auditing the process parameters for one or more sub-processes, adjusting the parameters for one or more sub-processes, testing the activity of a disinfectant or enzyme, replacing a chemical; replacing process equipment, performing equipment maintenance, increasing the frequency of process monitoring, generating an alert, and generating a report.

Embodiment 23 is a computer readable medium comprising computer readable instructions that, when executed in a processor, the processor:

receives a first set of numerical values associated with a first quantified analyte from a first group of articles subjected to a first sub process of a multi-step process;

receives a second set of numerical values associated with a second quantified analyte from a second group of articles subjected to a second sub process of the multi-step process;

receives a third numerical value associated with a control;

uses the third numerical value to calculate a first normalized value associated with the first quantified analyte;

uses the third numerical value to calculate a second normalized value associated with the second quantified analyte;

calculates a first average normalized value for the first group;

calculates a second average normalized value for the second group;

calculates a first action limit using the first average normalized value; and

calculates a second action limit using the second average normalized value.

Embodiment 24 is the computer readable medium of embodiment 23, wherein receiving a third numerical value further comprises receiving two or more numerical values associated with a control and calculating the average of the two or more numerical values to generate the third numerical value.

Embodiment 25 is the computer readable medium of embodiment 23 or embodiment 24 that, when executed in a processor, the processor further:

receives a third set of numerical values associated with a third quantified analyte from the first group of articles subjected to the first sub process of the multi-step process;

uses the third numerical value to calculate a third normalized value associated with the third quantified analyte;

calculates a third average normalized value for the first group; and

calculates a third action limit using the first average normalized value.

Embodiment 26 is the computer readable medium of any one of claims 23 through 25 that, when executed in a processor, the processor further:

receives a fourth set of numerical values associated with a fourth quantified analyte from the second group of articles subjected to the second sub process of the multi-step process;

uses the third numerical value to calculate a fourth normalized value associated with the fourth quantified analyte;

calculates a fourth average normalized value for the second group; and

calculates a second action limit using the second average normalized value.

Embodiment 27 is a computer readable medium comprising computer readable instructions that, when executed by a processor, the processor:

receives first and second action limits selected according to any one of embodiments 1 through 21;

receives a biological analyte test value associated with an article that has been processed using the first or second sub processes;

receives a control value;

uses the test value and the control value to calculate a normalized test value; and

compares the normalized test value to the first or second action limit.

Embodiment 28 is the computer readable medium of embodiment 27 comprising computer readable instructions that, when executed by a processor, the processor further:

receives a third action limit or fourth action limit selected according to any one of embodiments 14 through 21;

uses the test value and the control value to calculate a normalized test value; and

compares the normalized test value to the third or fourth action limit.

Embodiment 29 is the computer readable medium of embodiment 27 or embodiment 28 wherein, when the computer readable instructions are executed by a processor, the processor further executes a predetermined action when the normalized test value exceeds the first or second action limit.

Embodiment 30 is the computer readable medium of embodiment 29, wherein the predetermined action is selected from the group consisting of generating an alert signal, generating a report, initiating a tracking function, performing a site comparison, scheduling a maintenance event, and disabling one or more sub processes of the multi-step processes.

Embodiment 31 is a system, comprising:

an instrument for quantifying a biological analyte from a residue;

a processor; and

the computer readable medium of any one of embodiments 12 through 14.

The present invention is illustrated by the following examples. It is to be understood that the particular examples, materials, amounts, and procedures are to be interpreted broadly in accordance with the scope and spirit of the invention as set forth herein.

### EXAMPLES

### Example 1

### Monitoring the Efficacy of a Multi-Step Decontamination Process

All the data in this Example were collected from three different clinical sites (i.e., hospitals and clinic facilities) using the 3M CLEAN-TRACE SURFACE ATP test and the 3M CLEAN-TRACE NG Luminometer, both available from 3M Company of St. Paul, Minn. The ATP test devices and luminometer were used according to the manufacturer's instructions, with the exception that the area swabbed was not 10 cm by 10 cm. Instead, either a portion of a medical instrument was swabbed or the entire instrument was swabbed, as indicated in Tables 1-3. The protocol used to collect samples and generate data is described below.

Instrument Selection:

Medical instruments were selected with the assistance of Sterilization Process Department personnel. Typically, 3 to 5 individual instruments of each instrument type were selected such that:
a. at least 1 instrument was considered dirty and/or heavily soiled and relatively hard to clean;
b. at least 1 instrument was considered dirty and/or heavily soiled and relatively easy to clean; and
c. at least 1 instrument was considered lightly soiled.

Process Points for Sampling:

The medical instruments were tracked and sampled at the following points in the decontamination process:
a. After they arrived at the Sterile Processing Facility (in the initial dirty state; i.e., before the decontamination process was initiated).
b. After the completion of a manual washing decontamination sub-process.
c. After the completion of a decontamination sub-process in an automated washer-disinfector.

NOTE: due to variation in wash protocols between the three clinical sites and the variety of instruments that were processed, some of the instruments were subjected to additional decontamination sub-processes, such as soaking in a detergent/enzyme solution and sonication, prior to the washer-disinfector decontamination sub-process.

Preparation of the Luminometer and the Swabs:

The 3M CLEAN-TRACE NG Luminometer, was turned on and swabs were labeled.

Sample Collection and Processing:

The following steps were performed after each step in the instrument decontamination process making sure to sample chosen instrumentation at the same test points at each decontamination step:
a. Collected a negative control: At each step in the decontamination process and before sampling test instruments, a 3M™ Clean-Trace™ swab (control) was used to establish the background (no sample) luminescence reading.
b. Contacted a swab at predefined test points (i.e., locations on the surface of the medical instrument) for each medical instrument tested (the test points were selected according to the individual types of instruments):
   i. used 1 swab to sample (contact) the entire surface of the medical instrument;
   ii. used 1 swab to sample heavily soiled area;
   iii. used 1 swab to sample cannulae, lumens, openings, crevices, between blades, between mated surfaces, etc.; and/or
   iv. used 1 swab to sample surface that is visually clean or lightly soiled.
c. The type of instrument and area where swab samples were obtained was noted, so that the same areas (e.g., total surface or predefined partial surface) were sampled as the instruments progress through each step of the decontamination process.
d. The following instructions were used when obtaining samples from each of the medical instruments:
   i. Remove the swab from its protective device tube.
   ii. After contacting the swab with the surface of the medical instrument, apply enough pressure to cause the swab shaft to bend slightly, then move the swab in a zigzag fashion over sample area.
   iii. Return the swab to the protective device tube.
      Note: Swabs were stored for up to 4 hours in the protective cover before they were processed to detect ATP according to the manufacturer's instructions.
   iv. Push on the end of the swab hard enough for the swab to break the protective barrier at the bottom of the CLEAN-TRACE Surface ATP test tube.
   v. Swish the swab and tube in a pendulum motion for approximately 5 seconds, then immediately place the tube in the luminometer monitor to obtain reading.
   vi. Depress the appropriate button on the luminometer monitor to obtain a measurement.
   vii. Record RLU (Relative Light units) reading.
   viii. Remove the swab and tube from the luminometer and discard.

Negative Controls

In addition to the negative controls samples that were taken at each site prior to collecting samples, additional negative controls were created in a separate laboratory. Negative controls were prepared by removing a swab device from the foil pouch, but not taking the swab stick out of the tube, pushing down firmly on the top of the sample stick handle, sliding the handle into the device tube until the top of the handle is level with the top of the device tube when fully depressed. The top of the device was gripped and the device was shaken rapidly side-to-side for at least five seconds to simulate mixing the reagent with a collected sampled. In the same manner as actual samples, the negative control samples (swab device) were placed in the sample chamber of the CLEAN-TRACE Luminometer and read for RLU. A total of 66 negative control samples were collected and assayed for ATP with 3M Clean Trace. The average Log₁₀ RLU for the 66 negative control samples was 1.050 RLU, with a standard deviation of 0.161 Log₁₀ RLU.

Total Surface Swabs

At each site, with each set of instruments, a smaller data set was collected that included only the swab used to sample as much of the total area of an instrument as possible. See the protocol detailed above.

Although the average RLU values are slightly different between sites, and between total-surface swabs vs. partial-surface swabs, the same observations were made about the results: (1) the major steps of the wash and disinfection process are clearly separated from each other in terms of cleanliness according to ATP testing, (2) the initial RLU reduction after manual-washing is greater than 1.5 logs, (3) there is a further reduction of greater than 1.0 logs in RLU values after automated wash and disinfection, (4) The RLU average values characterizing instruments after completion of wash and disinfection are higher than the negative controls, and (5) Instruments that show the highest RLU values after automated wash and disinfection are also the same instruments that show elevated RLU values after manual-washing; this observation implies that instruments carrying higher bioburden after manual-washing will also emerge with higher bioburden after automated wash and disinfection.

TABLE 1
CLINICAL SITE NUMBER 1 - SWAB ATP RESULTS.

| | | | | | After |
|---|---|---|---|---|---|
| Instrument | | | | After | Automated |
| Description- | Sample | Swab | | Manual | Wash and |
| No. | Location | # | Initial | Wash | Disinfection |
| Trial-ball-1 | Total surface | 1 | 5.553 | 1.519 | 0.954 |
| Trial-ball-1 | Outside surface | 2 | 5.449 | 1.279 | 0.845 |
| Trial-ball-1 | Inside surface | 3 | 4.941 | 1.041 | 0.954 |
| Hip Impactor-2 | Total surface | 1 | 5.755 | 1.491 | 1.114 |
| Hip Impactor-2 | Plastic tip | 2 | 5.622 | 2.025 | 1.000 |
| Hip Impactor-2 | Handle | 3 | 4.452 | 1.477 | 0.903 |
| Screwdriver-3 | Total surface | 1 | 5.467 | 2.253 | 0.954 |
| Screwdriver-3 | Extreme tip | 2 | 4.744 | 1.568 | 0.954 |
| Screwdriver-3 | Internal | 3 | 5.257 | 2.954 | 1.041 |
| | tip/inside | | | | |
| Screwdriver-3 | Handle | 4 | 5.383 | 2.029 | 1.114 |
| Reamer-4 | Total | 1 | 6.024 | 4.015 | 1.892 |
| | surface | | | | |
| Reamer-4 | Handle | 2 | 4.936 | 1.833 | 0.954 |
| Reamer-4 | Ridged | 3 | 6.014 | 3.620 | 1.623 |
| | surface | | | | |
| Broach-5 | Total | 1 | 6.082 | 2.610 | 1.000 |
| | surface | | | | |
| Broach-5 | Tip | 2 | 5.964 | 1.892 | 1.000 |
| Broach-5 | Inserted | 3 | 4.935 | 2.500 | 1.079 |
| | between/ | | | | |
| | crevice | | | | |
| Broach-5 | Spiked | 4 | 5.752 | 3.198 | 0.903 |
| | surface | | | | |
| Stryker System 6 | Total | 1 | 5.752 | 2.352 | — |
| Drill-6 | surface | | | | |
| Stryker System 6 | Internal | 2 | 4.299 | 1.531 | — |
| Drill-6 | drill head | | | | |
| Stryker System 6 | Drill bit | 3 | 5.372 | 2.013 | — |
| Drill-6 | | | | | |
| Stryker Drill-7 | Total | 1 | 5.767 | 2.104 | — |
| | surface | | | | |
| Stryker Drill-7 | Drill head | 2 | 4.051 | 1.146 | — |
| Stryker Drill Bits | Total | 1 | 3.801 | 1.279 | — |
| with Handle-8 | surface | | | | |
| Stryker Drill Bits | Under bit | 2 | 1.415 | 1.114 | — |
| with Handle-8 | inside surface | | | | |
| Drill Key-9 | Total | 1 | 4.975 | 1.431 | — |
| | surface | | | | |
| Scissors-10 | Total | 1 | — | 2.922 | 1.000 |
| | surface | | | | |
| Scissors-10 | Between | 2 | — | 3.311 | 0.903 |
| | blades | | | | |
| Clamp-11 | Total | 1 | — | 3.430 | 1.079 |
| | surface | | | | |
| Clamp-11 | Hinge | 2 | — | 2.225 | 1.000 |
| Clamp-11 | Ridged | 3 | — | 2.987 | 1.000 |
| | clamp inner | | | | |
| | face | | | | |
| Rake-12 | Total | 1 | — | 3.408 | 0.903 |
| | surface | | | | |
| Rake-12 | Between | 2 | — | 2.688 | 0.954 |
| | teeth | | | | |

| | | | |
|---|---|---|---|
| Average (All Tests) | 5.111 | 2.226 | 1.047 |
| Std Dev (All Tests) | 0.993 | 0.829 | 0.233 |
| Average (Partial Surface) | 4.912 | 2.122 | 1.014 |
| Std Dev (Partial Surface) | 1.094 | 0.789 | 0.176 |
| Average (Total Surface) | 5.464 | 2.401 | 1.112 |
| Std Dev (Total Surface) | 0.704 | 0.900 | 0.323 |

Normalized Values

| | | | |
|---|---|---|---|
| Average (All Tests) | 4.061 | 1.176 | −0.003 |
| Average (Partial Surface) | 3.862 | 1.072 | −0.036 |
| Average (Total Surface) | 4.414 | 1.351 | 0.062 |

All values are reported as the Log₁₀ Relative Light Units.
Normalized values were calculated by subtracting the average Negative Control Value (1.050 Log₁₀ RLU) from the Log₁₀ RLU average test values.

TABLE 2
CLINICAL SITE NUMBER 2 - SWAB ATP RESULTS.

| | | | | | After |
|---|---|---|---|---|---|
| | | | | After | Automated |
| Instrument | Sample | Swab | | Manual | Wash and |
| Description-No. | Location | No. | Initial | Wash | Disinfection |
| Rongeur-13 | Total surface | 1 | 5.089 | 2.840 | 1.380 |
| Rongeur-13 | Grooves on tip | 2 | 4.985 | 2.531 | 1.301 |
| Rongeur-13 | Inside connect | 3 | 5.049 | 2.076 | 1.322 |
| | point | | | | |
| Rongeur-13 | Outside handle | 4 | 5.279 | 3.507 | 1.000 |
| Rongeur-13 | Inside handle | 5 | 5.582 | — | 1.041 |
| Hammer-14 | Total surface | 1 | 5.172 | — | 1.255 |
| Hammer-14 | Head | 2 | 4.831 | — | 1.146 |
| Hammer-14 | Outer handle | 3 | 5.576 | 4.026 | 1.477 |
| Hammer-14 | Inner handle | 4 | 5.032 | — | 1.041 |
| Lombardi | Total surface | 1 | 5.256 | 3.744 | 1.778 |
| Atromatic | | | | | |
| Spreader-15 | | | | | |
| Lombardi | Spreader tip | 2 | 4.458 | 3.343 | 1.342 |
| Atromatic | | | | | |
| Spreader-15 | | | | | |
| Lombardi | Hinge | 3 | 4.560 | 2.342 | 1.041 |
| Atromatic | | | | | |
| Spreader-15 | | | | | |
| Lombardi | Handle and | 4 | 4.895 | 3.294 | 1.322 |
| Atromatic | adjustable | | | | |
| Spreader-15 | piece | | | | |
| Cobbs-16 | Total surface | 1 | 5.266 | 4.115 | 1.146 |
| Cobbs-16 | Handle | 2 | 5.448 | 4.120 | 1.146 |
| Cobbs-16 | Tip | 3 | 3.854 | 4.005 | 1.544 |
| L-Shaped | Total surface | 1 | 4.401 | — | 1.079 |
| Spreader-17 | | | | | |
| L-Shaped | Handle | 2 | 4.546 | — | 1.041 |
| Spreader-17 | | | | | |
| L-Shaped | Tip | 3 | 3.605 | 3.294 | 0.699 |
| Spreader-17 | | | | | |

| | | | |
|---|---|---|---|
| Average (All Tests) | 4.889 | 3.326 | 1.216 |
| Std Dev (All Tests) | 0.540 | 0.696 | 0.240 |
| Average (Partial Surface) | 4.836 | 3.254 | 1.176 |
| Std Dev (Partial Surface) | 0.593 | 0.725 | 0.223 |
| Average (Total Surface) | 5.037 | 3.566 | 1.328 |
| Std Dev (Total Surface) | 0.363 | 0.656 | 0.276 |

Normalized Values

| | | | |
|---|---|---|---|
| Average (All Tests) | 3.839 | 2.276 | 0.166 |
| Average (Partial Surface) | 3.786 | 2.204 | 0.126 |
| Average (Total Surface) | 3.987 | 2.516 | 0.278 |

All values are reported as the Log₁₀ Relative Light Units.
Normalized values were calculated by subtracting the average Negative Control Value (1.050 Log₁₀ RLU) from the Log₁₀ RLU average test values.

TABLE 3
CLINICAL SITE NUMBER 3 - SWAB ATP RESULTS.

| | | | | | After |
|---|---|---|---|---|---|
| | | | | After | Automated |
| Instrument | Sample | Swab | | Manual | Wash and |
| Description-No. | Location | No. | Initial | Wash | Disinfection |
| Long forceps-18 | Total | 1 | 5.480 | 3.263 | 1.230 |
| | surface | | | | |
| Long forceps-18 | Handle | 2 | 5.008 | 2.238 | — |
| Long forceps-18 | Hinge | 3 | 4.382 | 1.845 | — |
| Long forceps-18 | Serrated | 4 | 2.916 | 3.657 | — |
| | grip | | | | |
| Long rod-19 | Total | 1 | — | 4.672 | 1.000 |
| | surface | | | | |
| Long rod-19 | Looped end | 2 | 4.776 | 3.264 | — |
| Long rod-19 | Rod shaft | 3 | — | 2.267 | — |
| Long rod-19 | Handle | 4 | 4.684 | — | — |
| Graves | Total | 1 | 5.548 | 2.939 | 0.903 |
| (spreader/brace)- | surface | | | | |
| 20 | | | | | |
| Graves | Lock end | 2 | 5.541 | 2.851 | — |
| (spreader/brace)- | | | | | |
| 20 | | | | | |
| Graves | Clamp end | 3 | 3.788 | 2.164 | — |
| (spreader/brace)- | | | | | |
| 20 | | | | | |
| Larger rod with | Total | 1 | 6.024 | 3.422 | 1.041 |
| white handle-21 | surface | | | | |
| Larger rod with | Handle | 2 | 6.022 | 3.588 | — |
| white handle-21 | | | | | |
| Impactor-22 | Total | 1 | 5.949 | 4.045 | 1.380 |
| | surface | | | | |
| Impactor-22 | Shaft | 2 | 5.977 | 2.369 | — |
| Impactor-22 | Rigid | 3 | 5.672 | 3.061 | — |
| | handle | | | | |
| Broach-23 | Total | 1 | — | 2.758 | 1.041 |
| | surface | | | | |
| Reamer-24 | Total | 1 | 5.599 | 4.298 | 1.708 |
| | surface | | | | |
| Reamer-24 | Ridged | 2 | 5.165 | 4.282 | — |
| | surface | | | | |
| Reamer-24 | Handle | 3 | 5.414 | 2.569 | — |
| Ridged reamer-25 | Total | 1 | — | 4.152 | 1.447 |
| | surface | | | | |

| | | | |
|---|---|---|---|
| Average (All Tests) | 5.173 | 3.185 | 1.219 |
| Std Dev (All Tests) | 0.852 | 0.820 | 0.275 |
| Average (Partial Surface) | 4.945 | 2.846 | — |
| Std Dev (Partial Surface) | 0.917 | 0.736 | — |
| Average (Total Surface) | 5.720 | 3.694 | 1.219 |
| Std Dev (Total Surface) | 0.249 | 0.693 | 0.275 |

Normalized Values

| | | | |
|---|---|---|---|
| Average (All Tests) | 4.123 | 2.135 | 0.169 |
| Average (Partial Surface) | 3.895 | 1.796 | — |
| Average (Total Surface) | 4.670 | 2.644 | 0.169 |

All values are reported as the Log₁₀ Relative Light Units.
Normalized values were calculated by subtracting the average Negative Control Value (1.050 Log₁₀ RLU) from the Log₁₀ RLU average test values.

### Example 2

### Establishing Action Limits for Wash and Decontamination of Non-Lumened Instruments: Scissors and Forceps

Example 2 demonstrated the feasibility of using an ATP assay to define process control parameters for the multi-step wash and disinfection process (manual cleaning and automated wash and disinfection).

Surgical instruments from surgical procedure trays in the Central Sterilization department of a hospital were tested using an ATP assay. Two types of surgical instruments were sampled to create two separate instrument groups: scissors and forceps. Samples were collected and processed according to the procedure described in Example 1 using the 3M CLEAN-TRACE SURFACE ATP test and the 3M CLEAN-TRACE NG Luminometer, both available from 3M Company of St. Paul, Minn. Instruments were sampled after the manual cleaning step as well as after automated wash and disinfection. The pass, caution and fail action limits were derived using statistical analysis to generate I-MR control charts of the RLU data, and correspond to the mean RLU value plus 2*sigma (pass to caution threshold) and the mean RLU value plus 3*sigma (caution to fail threshold). Table 4 below shows the mean RLUs value and the action limits for scissors. Table 5 below shows the mean RLUs value and the action limits for forceps.

TABLE 4
Means and action limits for scissors

| | Scissors (N = 34) | | | |
|---|---|---|---|---|
| | Mean | Pass Range | Caution Range | Fail Range |
| Process Step | (RLUs) | (RLUs) | (RLUs) | (RLUs) |
| Manual Cleaning | 83 | <736 | 736-2186 | >2186 |
| Automated W/D | 16 | <44 | 44-72 | >72 |

TABLE 5
Means and action limits for forceps

| | Forceps (N = 25) | | | |
|---|---|---|---|---|
| | Mean | Pass Range | Caution Range | Fail Range |
| Process Step | (RLUs) | (RLUs) | (RLUs) | (RLUs) |
| Manual Cleaning | 264 | <6918 | 6918-35236 | >35236 |
| Automated W/D | 16 | <33 | 33-47 | >47 |

### Example 3

### Long-Term Monitoring the Wash and Decontamination Process for Non-Lumened Instruments

Example 3 demonstrated the feasibility of using an ATP assay to monitor the multi-step wash and disinfection process (manual cleaning and automated wash and disinfection) over an extended period of time.

Three months after the data shown in Example 2 were collected to establish action limits for the multi-step process, scissors and forceps from the same hospital were tested daily during a two week period. Samples were collected and processed according to the procedure described in Example 1 using the 3M CLEAN-TRACE SURFACE ATP test and the 3M CLEAN-TRACE NG Luminometer, both available from 3M Company of St. Paul, Minn. Table 6 shows the number of scissor that tested as pass, caution, or fail according to the action limits originally established in Example 2. Table 7 shows the number of forceps that tested as pass, caution, or fail according to the action limits originally established in Example 2.

TABLE 6
Number of scissors that were assigned to “pass”, “caution”, or “fail”
categories, based upon the test results.

| | Scissors (N = 11) | | |
|---|---|---|---|
| Process Step | Pass | Caution | Fail |
| Manual Cleaning | 10 | 0 | 1 |
| Automated W/D | 10 | 0 | 1 |

TABLE 7
Number of forceps that were assigned to “pass”, “caution”, or “fail”
categories, based upon the test results.

| | Forceps (N = 11) | | |
|---|---|---|---|
| Process Step | Pass | Caution | Fail |
| Manual Cleaning | 11 | 0 | 0 |
| Automated W/D | 9 | 0 | 2 |

### Example 4

### Establishing Action Limits for Decontamination of Non-Immersible Instruments

Example 4 demonstrated the feasibility of using an ATP assay to define process control parameters for the multi-step wash and disinfection process for non-immersible instruments.

Non-immersible surgical instruments cannot be placed in an automated wash and disinfector and therefore follow a different multi-step decontamination process: manual cleaning followed by wiping with alcohol. Non-immersible surgical instruments from surgical procedure trays in the Central Sterilization department of a hospital were tested using an ATP assay. Two types of instruments were sampled to create two separate instrument groups: cables and scopes. Samples were collected and processed according to the procedure described in Example 1 using the 3M CLEAN-TRACE SURFACE ATP test and the 3M CLEAN-TRACE NG Luminometer, both available from 3M Company of St. Paul, Minn. Instruments were sampled after the manual cleaning step as well as after wiping with alcohol. The pass, caution and fail action limits were derived using statistical analysis to generate I-MR control charts of the RLU data, and correspond to the mean RLU value plus 2*sigma (pass to caution threshold) and the mean RLU value plus 3*sigma (caution to fail threshold). Table 8 shows the mean RLUs value and the action limits for cables. Table 9 shows the mean RLUs value and the action limits for scopes.

TABLE 8
Means and action limits for cables

| | Cables (N = 16) | | | |
|---|---|---|---|---|
| | Mean | Pass Range | Caution Range | Fail Range |
| Process Step | (RLUs) | (RLUs) | (RLUs) | (RLUs) |
| Manual Cleaning | 150 | <1340 | 1340-5000 | >5000 |
| Alcohol Wipe | 24 | <125 | 125-340 | >340 |

TABLE 9
Means and action limits for scopes

| | Scopes (N = 12) | | | |
|---|---|---|---|---|
| | Mean | Pass Range | Caution Range | Fail Range |
| Process Step | (RLUs) | (RLUs) | (RLUs) | (RLUs) |
| Manual Cleaning | 150 | <1340 | 1340-5000 | >5000 |
| Alcohol Wipe | 63 | <500 | 500-1740 | >1740 |

### Example 5

### Establishing Action Limits for Decontamination of Flexible Lumened Medical Devices

Example 5 demonstrated the feasibility of using an ATP assay to define process control parameters for manual cleaning of flexible endoscopes.

Flexible endoscopes manually cleaned in the endoscopy suite of a hospital were tested using an ATP assay. Three type of endoscopes were selected to create three separate device groups: colonoscopes (Olympus model PCF-Q180AL), gastroscopes (Olympus model GIF-Q180), and duodenoscopes (Olympus model TJF-160VF). The inner lumen surface of the suction/biopsy channel for each one of the endoscopes tested was assayed according to the following procedure:

1. Install the suction valve on the manually cleaned scope.

2. Use a 60 mL luer-lock syringe to draw up 40 mL of air.

3. Attach the syringe to the suction connector of the S/B channel, holding down the suction valve; push the air in the syringe through scope, dislodging any cleaning agent remaining in the scope.

4. Remove the 60 mL luer-lock syringe and draw up 40 mL of sterile water from a sterile conical tube.

5. Draw up to the 60 mL mark with air.

6. Attach the syringe to the suction connector of the S/B channel.

7. With the distal end of the scope inside a sterile collection container and holding down the suction valve, push the water and air thru the scope and into the container (the air is necessary to remove all of the water injected into the scope).

8. Draw up another 30 mL of air and push through the channel to push all the rinse water into the same container.

9. Test the collected water sample using the 3M CLEAN-TRACE WATER TOTAL ATP test and the 3M CLEAN-TRACE NG Luminometer (available from 3M Company of St. Paul, Minn.), according to the manufacturer's instructions.

The pass, caution and fail action limits were derived using statistical analysis to generate I-MR control charts of the RLU data, and correspond to the mean RLU value plus 2*sigma (pass to caution threshold) and the mean RLU value plus 3*sigma (caution to fail threshold). Table 10 shows the mean RLUs value and the action limits for the three groups of endoscopes.

TABLE 10
Means and action limits for flexible endoscopes

| Action Limits | Colonoscopes | Gastroscopes | Duodenoscopes |
|---|---|---|---|
| (RLUs) | (N = 16) | (N = 12) | (N = 7) |
| Mean | 29 | 78 | 294 |
| Pass | <140 | <692 | <2499 |
| Caution Range | 140-303 | 692-2022 | 2499-7165 |
| Fail | >303 | >2022 | >7165 |

### Example 6

### Long-Term Monitoring the Decontamination of Flexible Lumened Medical Devices

Example 6 demonstrated the feasibility of using an ATP assay to monitor manual cleaning of flexible endoscopes over an extended period of time.

Using the same hospital site as in Example 5, flexible endoscopes from the three device groups of Example 5 (colonoscopes, gastroscopes, and duodenoscopes) were tested routinely during a period of one month, starting at a time point which was one month after the initial data shown in Example 5 had been collected to establish action limits for the manual cleaning process. Samples were collected and processed according to the procedure described in Example 5 using the 3M CLEAN-TRACE WATER TOTAL ATP test and the 3M CLEAN-TRACE NG Luminometer, both available from 3M Company of St. Paul, Minn. Table 11 below shows the number of endoscopes that tested as pass, caution, or fail according to the action limits established in Example 5.

TABLE 11
Number of endoscopes that were assigned to “pass”, “caution”,
or “fail” categories, based upon the test results.

| Action Limits | Colonoscopes | Gastroscopes | Duodenoscopes |
|---|---|---|---|
| (RLUs) | (N = 11) | (N = 12) | (N = 6) |
| Pass | 11 | 11 | 6 |
| Caution Range | 0 | 1 | 0 |
| Fail | 0 | 0 | 0 |

### Example 7

### Establishing Action Limits for Wash and Decontamination of Rigid Lumened instruments

Example 7 demonstrated the feasibility of using an ATP assay to define process control parameters for the multi-step wash and disinfection process (sonication and automated wash and disinfection).

Laparoscopic surgical instruments from surgical procedure trays in the Central Sterilization department of a hospital were tested using an ATP assay. These laparoscopic instruments have an exterior surface readily sampled using the 3M CLEAN-TRACE SURFACE ATP test and the 3M CLEAN-TRACE NG Luminometer, (available from 3M

Company of St. Paul, Minn.), following the procedure described in Example 1. Furthermore, the laparoscopic instruments also have an inner lumen surface that can be tested using the 3M CLEAN-TRACE WATER TOTAL ATP test and the 3M CLEAN-TRACE NG Luminometer (available from 3M Company of St. Paul, Minn.), using the procedure described in Example 5. This allows a user to establish action limits specific to the exterior and inner surfaces of this type of surgical instrumentation (rigid lumened devices). Laparoscopic instruments were sampled after the sonication step as well as after automated wash and disinfection. As in the previous examples, the pass, caution and fail action limits were derived using statistical analysis to generate I-MR control charts of the RLU data, and correspond to the mean RLU value plus 2*sigma (pass to caution threshold) and the mean RLU value plus 3*sigma (caution to fail threshold). Table 12 shows the mean RLUs value and the action limits for lumened laproscopic instruments.

TABLE 12
Means and action limits for lumened laproscopic instruments

| | ATP Surface Test | | | | ATP Water Test | | | |
|---|---|---|---|---|---|---|---|---|
| | | Pass | Caution | Fail | | Pass | Caution | Fail |
| Process | Mean | Range | Range | Range | Mean | Range | Range | Range |
| Step | (RLUs) | (RLUs) | (RLUs) | (RLUs) | (RLUs) | (RLUs) | (RLUs) | (RLUs) |
| Sonication | 170 | <3900 | 3900- | >18700 | 396 | <8000 | 8000- | >35700 |
| | | | 18700 | | | | 35700 | |
| Automated | 31 | <150 | 150-328 | >328 | 90 | <1000 | 1000- | >3330 |
| W/D | | | | | | | 3330 | |

The invention illustratively described herein suitably may be practiced in the absence of any element(s) not specifically disclosed herein. Thus, for example, in each instance herein any of the terms “comprising”, “consisting essentially of”, and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method of controlling a multi-step decontamination process, comprising
selecting a multi-step decontamination process to disinfect an article, the process comprising a first sub process and a second sub process;
assigning articles into a first group and a second group, each group comprising a plurality of the articles;
using the first group to
process the first-group articles using a first sub process;
collect a first residue from a first predetermined sample region of two or more first-group articles;
quantify a biological analyte to generate a first test value for each residue collected from the two or more first-group articles;
use the first test value and a control value to generate a first normalized value for each of the two or more first-group articles;
using the second group to
process the second-group articles using a second sub process;
collect a second residue from a second predetermined sample region of two or more second-group articles;
quantify a biological analyte to generate a second test value for each residue collected from the two or more second-group articles;
use the second test value and the a control value to generate a second normalized value for each of the two or more second-group articles;
using a plurality of first normalized values to select a first action limit for articles that are processed using the first sub process; and
using a plurality of second normalized values to select a second action limit for articles that are processed using the second sub process.

2. The method of claim 1, wherein a first article is in both the first group and the second group of articles.

3. The method of claim 1, wherein the second-group articles are processed in the first sub process before they are processed in the second sub process.

4. The method of claim 1, wherein partitioning articles into the first and second groups further comprises selecting a first portion and a second portion of at least one of the first or second groups, wherein the articles in the first and second portions are selected on the basis of having different types or quantities of visible residue thereon.

5. The method of claim 1, wherein each article of the plurality of articles comprises a medical article.

6. The method of claim 1, wherein the plurality of articles in the first group and/or the plurality of articles in the second group comprise similar articles.

7. The method of claim 1, wherein the plurality of articles in the first group and/or the plurality of articles in the second group comprise two or more dissimilar articles.

8. The method of claim 1, wherein selecting a first action limit further comprises calculating an average of a plurality of the first normalized values and selecting a second action limit further comprises calculating an average of a plurality of the second normalized values.

9. The method of claim 1, further comprising:
using the first group to:
collect a third residue from a third predetermined sample region of the two or more first-group articles;
quantify a biological analyte to generate a third test value for each of the third residues collected;
use the third test value and a control value to generate a third normalized value for each of the two or more first-group articles; and
use a plurality of the third normalized values to select a third action limit for articles that are processed using the first sub process; or
using the second group to:
collect a fourth residue from a fourth predetermined sample region of the two or more second-group articles;
quantify a biological analyte to generate a fourth test value for each of the residues collected;
use the fourth test value and the a control value to generate a fourth normalized value for each of the two or more second-group articles; and
use a plurality of fourth normalized values to select a fourth action limit for articles that are processed using the second sub process.

10. The method of claim 1, further comprising:
using the first group to:
collect a third residue from a third predetermined sample region of the two or more first-group articles;
quantify a biological analyte to generate a third test value for each of the third residues collected;
use the third test value and a control value to generate a third normalized value for each of the two or more first-group articles;
use a plurality of the third normalized values to select a third action limit for articles that are processed using the first sub process; and
using the second group to:
collect a fourth residue from a fourth predetermined sample region of the two or more second-group articles;
quantify a biological analyte to generate a fourth test value for each of the residues collected;
use the fourth test value and the a control value to generate a fourth normalized value for each of the two or more second-group articles; and
use a plurality of fourth normalized values to select a fourth action limit for articles that are processed using the second sub process.

11. The method of claim 1, wherein at least one of the first, second, third and fourth predetermined sample regions comprises an exterior surface.

12. The method of claim 1, wherein at least one of the first, second, third and fourth predetermined sample regions comprises an interior surface.

13. The method of claim 12, wherein the interior surface comprises the interior of a lumened device.

14. A method of monitoring the control of a multi-step decontamination process, comprising:
selecting first and second action limits for according to claim 1;
processing an article using the first sub process or the second sub process;
after the processing, collecting and quantifying a biological analyte from residue collected from a predetermined sample region of the article to generate a test value;
using the test value and a control value to generate a normalized value; and
performing a predetermined action if the normalized value exceeds the first or second action limit.

15. A computer readable medium comprising computer readable instructions that, when executed in a processor, the processor:
receives a first set of numerical values associated with a first quantified analyte from a first group of articles subjected to a first sub process of a multi-step process;
receives a second set of numerical values associated with a second quantified analyte from a second group of articles subjected to a second sub process of the multi-step process;
receives a third numerical value associated with a control;
uses the third numerical value to calculate a first normalized value associated with the first quantified analyte;
uses the third numerical value to calculate a second normalized value associated with the second quantified analyte;
calculates a first average normalized value for the first group;
calculates a second average normalized value for the second group;
calculates a first action limit using the first average normalized value; and
calculates a second action limit using the second average normalized value.

16. The computer readable medium of claim 15 that, when executed in a processor, the processor further:
receives a third set of numerical values associated with a third quantified analyte from the first group of articles subjected to the first sub process of the multi-step process;
uses the third numerical value to calculate a third normalized value associated with the third quantified analyte;
calculates a third average normalized value for the first group; and
calculates a third action limit using the first average normalized value.

17. The computer readable medium of claim 15 that, when executed in a processor, the processor further:
receives a fourth set of numerical values associated with a fourth quantified analyte from the second group of articles subjected to the second sub process of the multi-step process;
uses the third numerical value to calculate a fourth normalized value associated with the fourth quantified analyte;
calculates a fourth average normalized value for the second group; and
calculates a second action limit using the second average normalized value.

18. A computer readable medium comprising computer readable instructions that, when executed by a processor, the processor:
receives first and second action limits selected according to claim 1;
receives a biological analyte test value associated with an article that has been processed using the first or second sub processes;
receives a control value;
uses the test value and the control value to calculate a normalized test value; and
compares the normalized test value to the first or second action limit.

19. The computer readable medium of claim 18 wherein, when the computer readable instructions are executed by a processor, the processor further executes a predetermined action when the normalized test value exceeds the first or second action limit.

20. A system, comprising:
an instrument for quantifying a biological analyte from a residue;
a processor; and
the computer readable medium of claim 15.
